(19) United States
(12) Patent Application Publication
(10) Pub. No.: US 2023/0017744 A1
(43) Pub. Date: Jan. 19, 2023

(54) FINGERPRINT-BASED ENROLMENT ON A CHIP CARD

(71) Applicant: IDEMIA FRANCE, COURBEVOIE (FR)

(72) Inventors: Yann-Loïc AUBIN, ASNIERES-SUR-SEINE (FR); Jean-François DEPRUN, PUTEAUX (FR); Laurent KAZDAGHLI, ORSAY (FR)

(21) Appl. No.: 17/786,691

(22) PCT Filed: Dec. 18, 2020
(86) PCT No.: PCT/FR2020/052561

§ 371 Date: Jun. 17, 2022

(30) Foreign Application Priority Data
Dec. 20, 2019 (FR) FR1915263

(51) Int. Cl. G06F 21/32; G06F 21/34; G06V 40/50; G06V 40/13; G06V 40/12

(52) U.S. Cl. CPC G06F 21/32; G06F 21/34; G06V 40/50; G06V 40/1318; G06V 40/1365; G06V 40/1353

(57) ABSTRACT

The disclosure relates to an enrolment method carried out by a smart card using an internal or external electrical power supply, comprising: determining an applied mode among a first and second mode in which the electrical power supply is respectively below and above a predefined threshold; obtaining of N fingerprints in the form of image pixels, N being an integer greater than or equal to 2; extracting digital data representative of characteristic points of the fingerprints by a reading of the pixels at a predetermined resolution level; and generating a fingerprint template by aggregation of the digital data, the enrolment further comprising: determining based on the applied mode of at least one among the number N and the resolution level, so that the fingerprint template has a higher definition in the second mode than in the first mode.

### TECHNICAL FIELD

The present disclosure relates to fingerprint authentication, and relates more particularly to an enrolment implemented by a smart card to allow a subsequent authentication of a user.

### PRIOR ART

In a known manner, a smart card can use biometric data to authenticate a user, the result of this authentication making it possible for example to validate or reject a transaction implemented by this smart card. Particularly, the fingerprint verification allows securely authenticating the user of a smart card.

Thus, to authenticate a user, a smart card can acquire a fingerprint by means of any digital sensor and compare this fingerprint with a reference fingerprint template which is previously generated and stored in a memory of the smart card during a step called enrolment step. By verifying whether the acquired fingerprint and the reference fingerprint template match, the smart card can thus determine whether the authentication is successful or has failed.

For the digital authentication to offer reliable results, the reference fingerprint template pre-recorded in the smart card must be as faithful as possible regarding the user's finger(s). The enrolment step during which the user records his fingerprint is therefore critical.

However, the complexity of the enrolment step varies depending on the case and depends in particular on the sensitivity of the fingerprint sensor, on the number of fingerprints to be acquired by the smart card and, more generally, on the configuration of the smart card and of the digital sensor in question. It is not always easy for a user to carry out an enrolment of one or several fingers adequately, in particular due to the variable complexity of the enrolment procedure, to the variable sensitivity of the digital sensors, to the more or less limited time in which this enrolment must be done and, more generally, to the variable conditions in which the user may be to carry out this procedure. Climatic conditions (humidity, temperature, etc.) can also influence the quality of the acquired fingerprints during the enrolment step. The constraints in which the enrolment step takes place can particularly be strongly related to the resources, often limited, available to the smart cards.

There is consequently a need for a solution allowing a smart card to reliably and efficiently authenticate a user by means of his fingerprints. Particularly, it is necessary to allow a smart card to carry out authentications by fingerprint in an optimal manner, despite the variable contexts in which a user and the smart card may be. It is particularly necessary to allow a smart card to use reference fingerprint templates that are as faithful as possible regarding the users.

### SUMMARY

To this end, the present disclosure relates to a fingerprint enrolment (or processing) method implemented by a smart card comprising a memory, the method comprising the execution of a first enrolment by using an electrical power supply provided by a power supply source internal or external to said smart card, said first enrolment comprising:
obtaining of N first fingerprints in the form of image pixels representative of said fingerprints, N being an integer greater than or equal to 2;
analysis of the N obtained first fingerprints, in which digital data representative of characteristic points of said fingerprints are extracted by a reading of the image pixels at a predetermined resolution level; and
generation of a fingerprint template by aggregation of at least said digital data extracted from the N first fingerprints,
the first enrolment further comprising:
determination of a mode, called applied mode, in which the first enrolment is carried out, the applied mode being a first mode if the electrical power supply is below a predefined threshold and being a second mode if the electrical power supply is above or equal to the predefined threshold;
adaptation of at least one parameter among said number N and said resolution level according to the mode applied during the first enrolment, said at least one parameter being set to be higher in the second mode than in the first mode so that the fingerprint template has a higher definition level in the second mode than in the first mode.

The present disclosure advantageously allows the smart card to reliably and efficiently authenticate a user by means of fingerprints. Thanks to the disclosure, the smart card can carry out fingerprint authentications in an optimal manner despite the variable contexts in which a user and the smart card may be. This is in particular possible because the smart card of the disclosure can generate the richest and most complete fingerprint template possible, within the limits imposed by the electrical power supply (and therefore processing) resources available to the smart card to execute the enrolment.

According to one particular embodiment, the method comprises:
recording of the fingerprint template in the memory to allow the subsequent authentication of fingerprints by comparison with the fingerprint template.

According to one particular embodiment, in which the electronic device acquires the fingerprints by means of a fingerprint sensor embedded in said electronic device or by cooperating with an external device comprising a fingerprint sensor.

According to one particular embodiment, the method comprises:
acquisition of a signal from an external device with which the smart card cooperates during the first enrolment; and
determination, from the signal, of the mode applied during said first enrolment by applying a predefined rule.

According to one particular embodiment, the smart card comprising at least one communication interface for cooperating with at least one external device, the smart card being able to receive, via said at least one communication interface, an electrical power supply from said at least one external device serving as a power supply source;

wherein the smart card determines the mode applied during said first enrolment according to the use of said at least one communication interface.

According to one particular embodiment, the method comprises:
assessment of the level of the electrical power supply provided by the electrical source;
comparison of the level of the electrical power supply with the predefined threshold; and
determination of the mode applied during the first enrolment from a result of said comparison.

According to one particular embodiment, the characteristic points comprise fingerprint minutiae.

According to one particular embodiment, the number N of first fingerprints obtained to carry out the first enrolment is adapted so as to be higher in the second mode than in the first mode, the amount of aggregated digital data to generate the fingerprint template being a function of the number N.

According to one particular embodiment, the predetermined resolution level applied during the analysis is adapted so as to be higher in the second mode than in the first mode, the amount of aggregated digital data to generate the fingerprint template being a function of said predetermined resolution level.

According to one particular embodiment, said analysis comprises:
the selection of all or part of the image pixels of each first fingerprint; and
the assessment of a color characterizing respectively each selected pixel so as to locate predetermined characteristic points in said first fingerprint.

According to one particular embodiment, said assessment of a color of each selected pixel is carried out from a reading of said selected pixel and a reading of X pixels neighboring said selected pixel, X being an integer greater than or equal to 0 which is adapted to be greater in the second mode than in the first mode.

According to one particular embodiment, said assessment comprises the generation, for each selected pixel, of a respective color encoded according to a predetermined encoding level, the predetermined encoding level being adapted so as to be of better quality in the second mode than in the first mode, the digital data being extracted from the encoded colors for each selected pixel.

According to one particular embodiment, the smart card acquires and analyzes the N first fingerprints in a predetermined time range, said time range being adapted so as to be greater in the second mode than in the first mode.

According to one particular embodiment, the first enrolment comprises:
determination, for each first fingerprint obtained during said first enrolment, of a level of overlap of said first fingerprint vis-à-vis another first fingerprint or vis-à-vis a pre-existing fingerprint template from which said fingerprint template is generated during said generation; and
verification, for each first fingerprint, that the determined level of overlap reaches a predetermined minimum level of overlap, the predetermined minimum level of overlap being adapted so as to be higher if no initial enrolment, other than the first enrolment, was carried out prior to the first enrolment only in the opposite case;
wherein the fingerprint template is generated from the digital data extracted from each first fingerprint for which the level of overlap reaches the predetermined minimum level of overlap.

According to one particular embodiment, the first enrolment is executed upon detection that an authentication has previously passed successfully.

According to one particular embodiment, the first enrolment is executed upon detection that an authentication has previously passed successfully, the authentication comprising:
acquisition of second fingerprints;
determination that the authentication has passed successfully from a comparison of the second fingerprints, or data obtained from the second fingerprints, with an initial fingerprint template pre-recorded in the memory of the smart card during an initial enrolment before the execution of the first enrolment;
wherein, during the first enrolment, the first fingerprints obtained comprise at least one fingerprint selected among the second fingerprints acquired during said authentication.

According to one particular embodiment, the authentication comprises:
aggregation of the second fingerprints into a consolidated fingerprint; and
authentication of a user by comparing the consolidated fingerprint with the initial fingerprint template.

In one particular embodiment, the different steps of the enrolment method are determined by computer program instructions.

Consequently, the disclosure also relates to a computer program on an information medium (or recording medium), this program being capable of being implemented in a smart card and more generally in a computer, this program including instructions adapted to the implementation of the steps of an enrolment method as defined in this document.

This program can be formed of several sub-parts stored in the same memory or in separate memories.

This program can use any programming language, and be in the form of source code, object code, or intermediate code between source code and object code, such as in partially compiled form, or in any other desirable form.

The disclosure also relates to an information medium (or recording medium) readable by the smart card of the disclosure, and more generally by a computer, and including instructions of a computer program as defined in this document.

The information medium can be any entity or device capable of storing the program. For example, the medium can include a storage means, such as a rewritable non-volatile memory or ROM, for example a CD ROM or a microelectronic circuit ROM, or a magnetic recording means, for example a floppy disk or a hard drive.

On the other hand, the information medium can be a transmissible medium such as an electrical or optical signal, which can be conveyed via an electrical or optical cable, by radio or by other means. The program according to the disclosure can be particularly downloaded over an Internet-type network.

Alternatively, the information medium can be an integrated circuit in which the program is incorporated, the circuit being adapted to execute or to be used in the execution of the method in question.

The present disclosure also relates to a corresponding smart card, configured to implement the enrolment method of the disclosure. More specifically, the disclosure relates to a smart card configured to carry out a fingerprint enrolment by using an electrical power supply provided by a power supply source internal or external to said smart card, said smart card comprising:
a memory;
a determination module configured to determine a mode, called applied mode, in which the first enrolment is carried out, the applied mode being a first mode if the electrical power supply is below a predefined threshold and being a second mode if the electrical power supply is above or equal to the predefined threshold;
an obtaining module configured to obtain N first fingerprints in the form of image pixels representative of said fingerprints, N being an integer greater than or equal to 2;
an analysis module configured to carry out an analysis of said N first fingerprints, in which digital data representative of characteristic points of said fingerprints are extracted by a reading of the image pixels at a predetermined resolution level; and
a generation module configured to generate a fingerprint template by aggregation of at least said digital data extracted from the N first fingerprints,
wherein the determination module is further configured to adapt, according to the applied mode, at least one parameter among said number N and said resolution level, said at least one parameter being set to be higher in the second mode than in the first mode such that the fingerprint template has a higher definition level in the second mode than in the first mode.

It should be noted that the different embodiments defined in this document in relation to the enrolment method of the disclosure as well as the associated advantages apply analogously to the smart card of the disclosure.

According to one embodiment, the disclosure is implemented by means of software and/or hardware components. From this perspective, the term “module” can correspond in this document to a software component, a hardware component or a set of hardware and software components.

A software component corresponds to one or several computer programs, one or several sub-programs of a program, or more generally to any element of a program or software able to implement a function or a set of functions, according to what is described in this document for the module concerned.

In the same way, a hardware component corresponds to any element of a hardware assembly able to implement a function or a set of functions, according to what is described in this document for the module concerned. It can be a programmable hardware component or with an integrated processor for the execution of software, for example an integrated circuit, a smart card, a memory card, an electronic card for the execution of firmware, etc.

### BRIEF DESCRIPTION OF THE DRAWINGS

Other characteristics and advantages of the present disclosure will become apparent from the description given below, with reference to the appended drawings which illustrate exemplary embodiments without any limitation. On the figures:

FIG. 1 schematically represents the structure of a smart card as well as the environment in which it interacts, in accordance with one particular embodiment of the disclosure;

FIG. 2 schematically represents modules implemented by the smart card, according to one particular embodiment of the disclosure;

FIGS. 3A, 3B and 3C schematically represent predefined rules applied by the smart card, according to particular embodiments of the disclosure;

FIG. 4 schematically represents, in the form of diagrams, steps of implementing an enrolment method, according to one particular embodiment of the disclosure;

FIG. 5 schematically represents the analysis of a fingerprint, according to one particular embodiment of the disclosure;

FIG. 6 schematically represents the analysis of a fingerprint, according to one particular embodiment of the disclosure;

FIG. 7 schematically represents, in the form of diagrams, steps of implementing an enrolment method according to one particular embodiment of the disclosure.

### DETAILED DESCRIPTION

As indicated above, the disclosure proposes according to various embodiments to allow the authentication of a user of a smart card from his fingerprints.

To do so, the disclosure particularly provides for an enrolment during which a smart card acquires fingerprints and analyzes them so as to extract therefrom digital data used to generate a digital fingerprint template. This fingerprint template can thus be stored by the smart card and then used later as a reference fingerprint to verify the validity of a fingerprint of a user wishing to authenticate himself with the smart card. The smart card is in particular able to operate according to two distinct operating modes—subsequently denoted first and second mode MD1, MD2—according to the level of electrical power supply (or electrical energy) it receives during the enrolment. The smart card determines one or several parameters to be applied during the enrolment according to the mode applied (that is to say according to the mode in which the smart card may be during said enrolment, and therefore according to the level of power supply it receives), so that the fingerprint template has a higher definition (or quality) in the second mode (high electrical power supply) than in the first mode (low electrical power supply).

As indicated in detail below, the disclosure aims in particular to adapt the quality of the fingerprint template generated by the smart card according to the context in which it may be, and more particularly according to the electrical power supply (electrical energy received) available to it to carry out the required analysis processing operations on the acquired fingerprints to produce the fingerprint template.

Given that a smart card generally does not have an internal power supply source, or at most a low-capacity internal power supply source, the disclosure aims to optimize the use of its resources according to the (internal and/or external) power supply source currently available to it during the enrolment, in order to generate a fingerprint template of the best possible quality given the power supply (and therefore processing) resources available to it.

In the present document, an “electrical power supply” refers to the electrical energy provided in any appropriate form (current, voltage, power), by an electrical power supply source (also called power supply source or electrical energy source), to the device to be powered (that is to say to the device of the disclosure in the following embodiments). An electrical power supply can be expressed for example in terms of provided power, provided voltage or provided current.

Aspects of the disclosure can be applied to any smart card, such as in particular a bank card (or payment card), a transport card, an access card, a health insurance card, an identity card, a voting card, a driver's license card, etc., able to carry out any transaction (for example a transaction to make an electronic voting, a transaction allowing access to identity data of the electronic device, a transaction to obtain physical or logical access, etc.).

According to one variant, aspects of the disclosure can apply more generally to electronic devices other than smart cards, able to process transactions, such as for example terminals (Smartphone, tablet, etc.). Aspects of the disclosure can be applied for example to terminals implementing a payment application to process a payment transaction in cooperation with an external terminal.

It should also be noted that the notion of transaction is understood in the broad sense in this document and comprises, for example, in the banking field, both a payment or transfer transaction and a consultation of a bank account on a bank terminal. Aspects of the disclosure are described below within the framework of a payment card intended to carry out bank transactions. It will be understood that other types of transactions or operations can be envisaged within the framework of the disclosure (electronic voting, transaction to access sensitive data, etc.).

Particularly, the disclosure applies to bank cards of the EMV (Europay Mastercard Visa) type or using other types of protocols.

Unless otherwise indicated, the elements common or similar to several figures bear the same reference signs and have identical or similar characteristics, so that these common elements are generally not described again for the sake of simplicity.

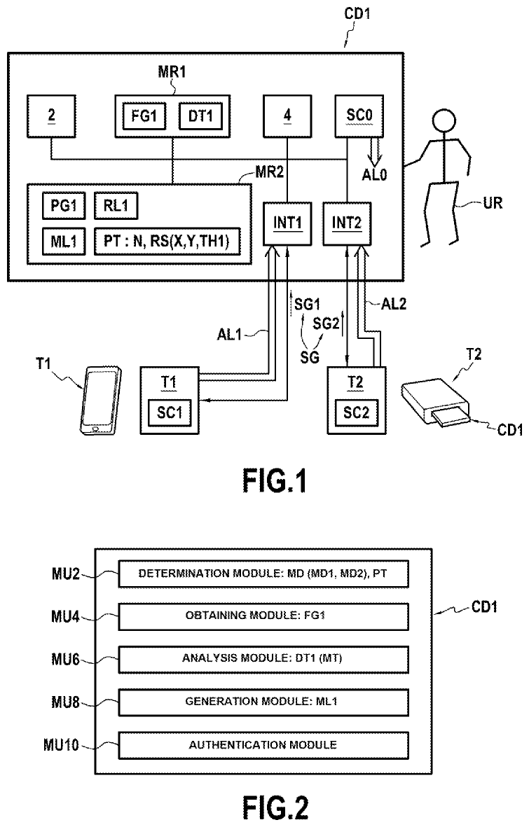

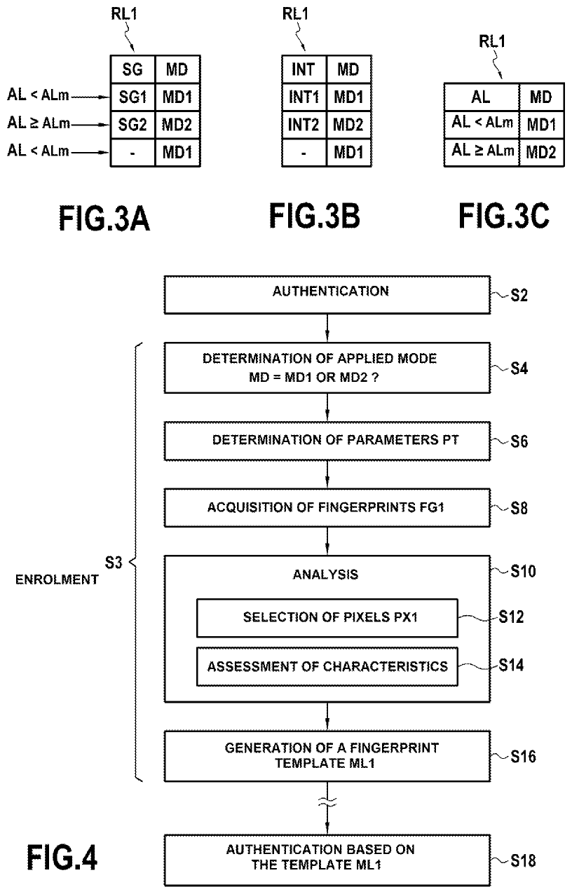

FIG. 1 schematically represents a smart card CD1 in accordance with one particular embodiment of the disclosure. This smart card CD1 is configured to implement an enrolment method (or processing method) according to any of the embodiments described below with reference in particular to FIGS. 3-7.

It is assumed in this example that the smart card CD1 is a bank card (or payment card). This smart card can have an ID-1 format specified in the ISO/IEC 7810 standard. The smart card CD1 can furthermore be a smart card with contacts (whose characteristics are detailed in the ISO/IEC 7816 standard) and/or a contactless smart card (whose characteristics are detailed in the ISO/IEC 14443 or NFC/ISO 15693 standard).

The smart card CD1 is for example configured to process payment transactions according to the EMV protocol.

As already indicated, other examples of smart cards and protocols are however possible.

In the example considered here, the smart card CD1 comprises a processor 2, a volatile memory (RAM) MR1, a rewritable non-volatile memory MR2, a fingerprint sensor (or fingerprint reader) 4, an internal electrical power supply source SC0 and communication interfaces INT1 and INT2.

The internal components of the smart card CD1 are monitored by the processor 2, for example by means of a data bus. Particularly, the processor 2 can use the volatile memory MR1 to temporarily store data generated during its operation, in particular to execute an enrolment (for example to temporarily store fingerprints FG1 acquired (or obtained) by the smart card CD1 as well as digital data DT1 generated during an enrolment from acquired fingerprints).

The rewritable non-volatile memory MR2 (for example of the Flash or EEPROM type) constitutes a recording medium (or information medium) in accordance with one particular embodiment, readable by the processor 2, and on which a first computer program PG1 is recorded in accordance with one particular embodiment. As a variant, the first program PG1 can be recorded in a read only memory (ROM) (not represented) of the smart card CD1.

The computer program (or application) PG1 include instructions for the execution of the steps of an enrolment method according to one particular embodiment, for example at least one of the exemplary methods described below.

As illustrated in FIG. 1, the memory MR2 can further be used to store a fingerprint template ML1, predefined rules RL1 as well as parameters PT applied by the card to execute an enrolment. According to variants, the parameters PT in particular can be recorded in another memory of the smart card CD1, for example in the volatile memory MR1 during the execution of an enrolment.

In the example considered here, the smart card CD1 includes a fingerprint sensor 4 allowing the acquisition of fingerprints FG1 of a user UR, in particular during an enrolment, then later when a user wishes to authenticate with the smart card CD1. However, the presence of a fingerprint sensor in the smart card CD1 is not mandatory. Alternatively or in addition, the smart card CD1 is configured to acquire fingerprints from an external terminal (for example T1 and/or T2 as described below) with which it cooperates, this external terminal (or device) including or using such a fingerprint sensor.

In the example considered here, the smart card CD1 also includes an internal electrical power supply source SC0 able to deliver an electrical power supply AL0 (of the electrical energy) to the smart card CD1. This internal source SC0 can thus be any battery embedded in the smart card CD1, such as for example a supercapacitor or a rechargeable battery, other examples being however possible. It should be noted that variants are also possible in which the smart card CD1 has no internal power supply source. As described below, the smart card CD1 is further configured to connect to at least one external electrical power supply source, the type may vary depending on the case. The way in which the smart card CD1 collects the electrical energy provided from outside may vary depending on the case (contact or contactless transmission, inductive transmission, etc.).

Still in this example, it is assumed that the smart card CD1 includes two communication interfaces INT1 and INT2 that allow communicating respectively with two external terminals (or devices) denoted T1 and T2, respectively. Thus, the smart card CD1 is capable in this example of cooperating with one among the two terminals T1 and T2 to carry out the method of the disclosure. It should be noted that the number and nature of the external devices with which the smart card CD1 can be coupled to carry out the disclosure may vary depending on the case.

Depending on the type of external terminals considered, the communication interfaces INT1 and INT2 can be contact or contactless communication interfaces. According to one particular example, the smart card CD1 has only one communication interface for communicating with the outside.

In the example considered here, the smart card CD1 is configured to communicate contactlessly with the terminal T1 via the communication interface INT1. To do so, the interface INT1 comprises an RF antenna for contactless communication, for example according to the ISO/IEC 14443 or NFC/ISO 15693 standard. The terminal T1 is for example a telecommunications terminal of the Smartphone or the like.

Furthermore, the smart card CD1 is configured in this example to communicate by contact with the external device T2 by means of the communication interface INT2. The interface INT2 comprises for example external contacts to establish a contact connection, according to the ISO/IEC 7816 standard or the like. The device T2 is for example a case (or the like) capable of at least partially accommodating the smart card to establish a contact connection.

According to one particular example, at least one among the devices T1 and T2 comprises a fingerprint sensor (not represented) allowing the smart card CD1 to acquire fingerprints remotely.

As already indicated, the smart card CD1 is able to collect a power supply received from outside the card. In the example envisaged here, the devices T1 and T2 both constitute external power supply sources—denoted respectively SC1, SC2—for the smart card CD1. Thus, once coupled with the smart card CD1, the external devices T1 and T2 are respectively capable of providing electrical power supplies (or electrical energy) AL1, AL2 to the smart card CD1. In this example, the electrical power supply AL1 is provided contactlessly to the smart card CD1 via the interface INT1 while the electrical power supply AL2 is provided by contact to the smart card CD1 via the interface INT2.

As understood by those skilled in the art, the smart card CD1 and its application environment as represented in FIG. 1 constitute only one non-limiting exemplary implementation of the disclosure. Particularly, some elements of the smart card CD1 are only described here to facilitate the understanding of the disclosure, these elements are not required for the implementation of the disclosure. Some elements generally present in a smart card have been deliberately omitted because they are not necessary for the understanding of the present disclosure.

As represented in FIG. 2 in one particular embodiment, the processor 2 driven by the computer programs PG1 implements a certain number of modules, namely: a determination module MU2, an obtaining module MU4, an analysis module MU6, a generation module MU8, and possibly an authentication module MU10.

The modules MU2-MU8 are in particular configured to execute a fingerprint enrolment, as described in more detail later. During such enrolment, the smart card CD1 uses an internal (SC0) or external (SC1 and/or SC2) power supply source to electrically power itself. According to one particular example, the smart card CD1 can use at least two separate power supplies at the same time to execute an enrolment. In this case, the power supply sources together form a global power supply source (internal, external, or mixed internal/external power supply source).

More specifically, the determination module MU2 is configured to determine a mode applied among a first mode MD1 and a second mode MD2. It is meant by “applied mode” the mode (MD1 or MD2) in which the smart card CD1 may be during the execution of the enrolment. According to the first mode MD1, the electrical power supply used by the smart card CD1 to execute the enrolment is below a predefined threshold ALm. On the other hand, according to the second mode MD2, the electrical power supply used by the smart card CD1 to execute the enrolment is above or equal to the predefined threshold ALm. In other words, if the electrical power supply received by the smart card CD1 to execute the enrolment is below the predefined threshold ALm, then it operates in the first mode MD1, otherwise it operates according to the second mode MD2. The threshold value ALm can be set by those skilled in the art on a case-by-case basis, depending in particular on the power supply needs of the smart card CD1 to carry out various processing operations during a fingerprint enrolment.

As described below, the determination module MU2 is also configured to determine at least one parameter PT to be applied during an enrolment.

The obtaining module MU4 is configured to acquire N fingerprints FG1, for example by means of the fingerprint sensor 4 or from one of the external devices T1, T2 with which it is likely to cooperate. As described below, the fingerprints are acquired in the form of image pixels representative of the fingerprints. In the example considered here, N is an integer greater than or equal to 2. Alternatively, N is an integer greater than or equal to 1.

The analysis module MU6 is configured to carry out an analysis of the N fingerprints FG1 acquired by the obtaining module MU4. During this analysis, digital data DT1 representative of characteristic points MT of the fingerprints FG1 are extracted by a reading of the image pixels at a predetermined resolution level RL. As described below, the smart card CD1 can act on this resolution level RL in different ways depending on the case.

The generation module MU8 is configured to generate a fingerprint template ML1 from at least the digital data DT1 extracted from the N first fingerprints. Particularly, the generation module MU8 can generate this template ML1 by aggregation of at least the digital data DT1 extracted by the analysis module MU6.

The generation module MU8 can thus record the fingerprint template ML1 in the non-volatile memory MR2 to allow the subsequent authentication of a user by comparison of at least one new fingerprint FG1 with the fingerprint template ML1 serving as reference.

Thus, the authentication module MU10 can be configured to authenticate a user UR by comparing a new fingerprint FG1 acquired by the obtaining module MU4 after the enrolment, with the fingerprint template ML1 stored in the memory MR2. If the new fingerprint matches the template ML1, then the authentication has passed successfully. Otherwise, the authentication fails or can possibly continue by performing the verification of at least another new fingerprint FG1.

As indicated above, the determination module MU2 is also configured to determine at least one parameter PT applied by the smart card CD1 during the enrolment. Thus, the determination module MU2 is configured to determine, according to the applied mode (MD1 or MD2), at least one parameter PT applied during the enrolment among the number N and the resolution level RL, said at least one parameter being set to be higher in the second mode MD2 than in the first mode MD1 so that the fingerprint template ML1 has a higher definition (or quality) in the second mode MD2 than in the first mode MD1.

In other words, the smart card CD1 can act on at least one of the parameters PT, namely the number N and the resolution level RL, to vary the complexity of the enrolment and thus adapt the quality of the fingerprint template ML1 depending on the electrical power supply level available during the enrolment.

According to one particular example, one of the parameter N and the resolution level RL is adapted (and therefore varies) during the enrolment according to the mode applied between MD1 and MD2, while the other parameter is set whatever the mode applied MD1/MD2.

According to another example, the two parameters N and RL are adapted (and therefore vary) during the enrolment according to the applied mode among MD1 and MD2.

Whatever the embodiment envisaged, the adaptation of one or of the two parameters N and RL is done so that the definition (or quality) of the fingerprint template ML1 thus generated is greater if the smart card CD1 operates in the second mode MD2 (high electrical power supply) than if it operates according to the first mode MD1 (lower electrical power supply).

As described below, several ways can be envisaged to allow the smart card CD1 to adapt the definition (or quality) of the fingerprint template ML1. This definition level is representative of the resolution and/or of the amount of information stored in the fingerprint template ML1, this information defining particularly characteristic points MT of a fingerprint. These characteristic points MT can particularly comprise minutiae characteristic of a fingerprint, as described below.

As also described later, the resolution level RL of the reading of the fingerprints FG1 during the enrolment can be monitored and adapted in various ways. The resolution level RL is characterized for example by at least the number of neighboring pixels that the smart card CD1 takes into account to read a pixel of the image representing the fingerprint, for example to determine the gray level (or the color) of said pixel. This particular case and variants are described below.

The configuration and operation of the modules MU2-MU10 of the smart card CD1 will appear more specifically in the exemplary embodiments described below with reference to FIGS. 3-7. It should be noted that the modules MU2-MU10 as represented in FIG. 2 only constitute one non-limiting exemplary implementation of the disclosure, other implementations being possible.

One particular embodiment is now described in particular with reference to FIGS. 3A-3C and 4. More specifically, the smart card CD1 as previously described implements an enrolment method (or processing method) by executing the computer program PG1.

It is assumed that an authentication step S2 is carried out by the smart card CD1 in order to authenticate a user UR wishing to enroll with the smart card CD1. This authentication S2 can be carried out in any way, for example by means of a verification of a secret PIN code or by verifying the validity of a fingerprint FG1 acquired by the smart card CD1.

Upon detection that the authentication S2 has passed successfully, the smart card CD1 executes an enrolment S3 by using an electrical power supply AL provided by a power supply source internal or external to the card CD1. This enrolment S3 comprises steps S4 to S16 described below.

As already described, it is considered in this example that the smart card CD1 embeds an internal power supply source SC0. However, it is assumed here that this internal source SC0 has a limited power supply capacity that is to say below a threshold value ALm. Furthermore, the smart card CD1 is able to cooperate with the external device T1 and/or T2 in particular in order to collect the electrical power supply AL1 and/or AL2 provided respectively by these devices.

During step S4, the smart card CD1 determines the applied mode MD (that is to say the mode MD in which the smart card CD1 may be, or operates) during the enrolment S3 among the modes MD1 and MD2. As already indicated, if the electrical power supply (or electrical energy) AL collected by the smart card CD1 during the enrolment S3 is below a predefined threshold ALm, it then operates according to the first mode MD1 (low electrical power supply). If, on the other hand, the electrical power supply AL collected by the smart card CD1 during the enrolment S3 is above or equal to this predefined threshold ALm, it then operates according to the second mode MD2 (high electrical power supply).

In other words, it is the threshold value ALm that defines in the present case the type of a power supply source, namely whether it is a source providing an electrical power supply called “low” electrical power supply (MD1) or a source providing an electrical power supply called “strong” electrical power supply (MD2). This threshold value ALm can be defined for example in terms of delivered power (or voltage, or current), and can be adapted by those skilled in the art according in particular to the needs in terms of power supply of the smart card CD1, in view in particular of the processing operations likely to be carried out by the card during the enrolment.

For simplicity, it is assumed in this example that the electrical power supply AL collected by the smart card CD1 during the enrolment S3 only comes from a single source SC0, SC1 or SC2, although other implementations are possible where the smart card CD1 can simultaneously collect the electrical power supply delivered by a plurality of electrical power supply sources. Thus, it is assumed that if the smart card CD1 is coupled with the device T1 or T2, it receives the corresponding electrical power supply AL1 or AL2 so that it does not use its internal source SC0 to be powered. Other implementations are however possible.

Thus, it is considered in the present case that the sources SC0 and SC1 constitute “low” power supply sources while the source SC2 constitutes a “high” power supply source. In other words, the electrical power supplies AL0 and AL1 delivered by the sources SC0 and SC1 are below the predefined threshold ALm, while the electrical power supply AL2 delivered by the source SC2 is above or equal to the predefined threshold ALm. It is assumed particularly that the Smartphone T1 is configured to provide a limited electrical power supply AL1 contactlessly (even if it has a more substantial power supply source than the smart card CD1) while the case T2 embeds here a power supply source SC2 able to provide a high power supply AL2 to the smart card CD1 when these two elements cooperate by contact. Other examples are however possible.

Different ways can be adopted by the smart card CD1 to determine in S4 in which mode MD1 or MD2 it operates during the enrolment S3 depending on the electrical power supply AL it detects. The smart card CD1 can particularly determine at least one parameter characterizing (directly or indirectly) the power supply source it uses and applies predefined rules RL1 stored in its memory MR2 to deduce therefrom whether it is the mode MD1 or MD2 that is applicable.

According to a first example represented in FIG. 3A, the smart card CD1 receives a signal SG identifying an external device (T1 or T2) with which it cooperates during the enrolment S3. The smart card CD1 receives in this example, via its communication interface INT1 or INT2, the signal SG1 or SG2 identifying the external devices T1 and T2 respectively. The smart card CD1 then determines (S4), from the received signal SG, the mode MD applied (either MD1 or MD2) during the enrolment S3 by applying the rules RL1. According to the example represented in FIG. 3A, the predefined rules RL1 specify that in response to the signal SG1 (respectively SG2), the smart card CD1 detects that it receives an electrical power supply AL lower than (respectively above or equal to) the predefined threshold ALm and deduces therefrom that it operates according to the first mode MD1 (respectively the second mode MD2). It is therefore considered in this particular example that the smart card CD1 is preconfigured to determine from the external device with which it cooperates whether the corresponding electrical power supply reaches or not the predefined threshold ALm.

According to one particular example, in the absence of a signal SL received during the enrolment S3 for which a mode MD1 or MD2 is specified in the rules RL1, the smart card CD1 determines (S4) in accordance with the rules RL1 that it operates in the first mode MD1 (low electrical power supply), assuming that it is the internal power supply source SC0 that is used.

According to one variant of the first example above, the signal SG received from an external device (T1 or T2) identifies the electrical power supply (SC1 or SC2) provided to the smart card CD1 during the enrolment S3. From the predefined rules RL1, the smart card CD1 can thus determine which mode (MD1 or MD2) to apply as a function of the signal SG received.

More generally, in this first exemplary embodiment, the signal SG comprises any information allowing the smart card CD1 to determine which mode (MD1 or MD2) to apply during the enrolment S3. According to another variant, the signal SG received from an external device (T1 or T2) identifies the mode to be applied (MD1 or MD2), so that no predefined rule RL1 is necessary.

According to a second example represented in FIG. 3B, the smart card CD1 determines in S4 the mode applied (MD1 or MD2) during the enrolment S3 according to the use of the communication interface(s) INT that the smart card includes (namely the communication interfaces INT1 and INT2 in the present case). Thus, the smart card CD1 determines if one of its communication interfaces INT1 and INT2 is used during the enrolment S3 (to cooperate with one of the external devices T1 and T2 in this example) and, if so, which of these communication interfaces is used. To do so, the processor 2 determines for example if there is an activity (signals, power supply etc.) on each of the communication interfaces INT1, INT2. It is assumed here that the smart card CD1 can use any one of the communication interfaces INT1, INT2 during the enrolment S3 or, alternatively, does not use any of the two communication interfaces INT1, INT2 to carry out the enrolment S3. Based on the use or not of its communication interfaces INT1, INT2, the smart card CD1 thus determines which of the modes MD1 and MD2 is applied during the enrolment S3.

According to the example represented in FIG. 3B, the predefined rules RL1 therefore specify that upon detection that the first communication interface INT1 (respectively the second communication interface INT2) is used during the enrolment S3, the smart card CD1 selects the first mode MD1 (respectively the second mode MD2) in S4. On the other hand, upon detection that none of the communication interfaces INT1, INT2 is used during the enrolment, the smart card CD1 selects the first mode MD1 in accordance with the predefined rules RL1. If the smart card CD1 is connected via one of its communication interfaces INT1, INT2 with an external device, this presupposes that it receives a respective electrical power supply AL1, AL2 from said communication interface. If neither of the two communication interfaces AL1, AL2 is used, the smart card CD1 is configured to use its own internal electrical power supply SC0. It is therefore considered in this particular example that the smart card CD1 is preconfigured to determine, from its use (or not) of its communication interfaces, whether the received electrical power supply reaches or not the predefined threshold ALm.

According to a third example represented in FIG. 3C, during the enrolment S3, the smart card CD1 assesses an electrical characteristic (power, voltage, current, etc.) of the electrical power supply AL it receives (or detects) coming from an internal or external power supply source. The smart card CD1 then compares the electrical power supply level detected from this characteristic, with the predefined threshold value ALm, and determines the mode applied (MD1 or MD2) during the enrolment S3 based on the result of this comparison. In the example considered here, by applying the rules RL1, the smart card CD1 therefore determines that it operates in the first mode MD1 if the electrical power supply AL received is below the predefined threshold ALm and operates in the second mode MD2 if the electrical power supply AL is above or equal to said predefined threshold ALm.

Still with reference to FIG. 4, following the determination step S4, the smart card CD1 determines (S6) at least one parameter PT it must apply during the enrolment S3. It is meant by “parameter to be applied” a parameter which is used by the smart card CD1 to carry out the enrolment S3. As described below, said at least one parameter PT comprises at least one among the number N applied in S8 and the resolution level RL applied in S10. During this step S6, it thus adapts this or these parameter(s) PT according to the mode MD1 or MD2 in which the smart card CD1 operates to carry out the enrolment S3. When the smart card CD1 operates according to the first mode MD1 (limited electrical power supply), it is necessary to limit the complexity and the processing time of the enrolment S3. On the other hand, in the second mode MD2 (high electrical power supply), the smart card CD1 has a higher electrical power supply and can therefore advantageously adapt its parameters PT in order to increase the complexity and the processing time of the enrolment. S3. The determination step S6 (also called adaptation step) and its consequences are described in more detail later.

During an acquisition step S8, the smart card CD1 acquires N fingerprints FG1, N being an integer greater than or equal to 2. These fingerprints FG1 obtained in S8 constitute “first” fingerprints digital within the meaning of the disclosure.

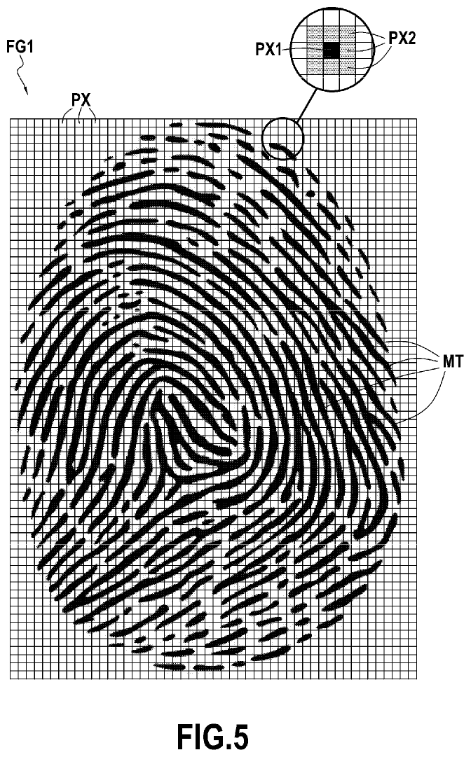

As schematically represented in FIG. 5, each fingerprint is acquired in S8 in the form of an image, namely an arrangement of image pixels PX, these pixels being representative of the fingerprint FG1 in question. Each pixel PX is characterized particularly by a gray level (or a color).

As indicated above, the number N of fingerprints FG1 acquired by the smart card CD1 at S8 can be adapted according to the applied mode MD1 or MD2. In other words, the smart card CD1 can apply in S8 a number N which is greater in the second mode MD2 than in the first mode MD1 to take into account the fact that the smart card CD1 has more energy in the mode MD2 and therefore can process more fingerprints FG1 during the enrolment S3.

According to one particular example, following the determination (S6) of the number N of fingerprints to be acquired in S8, the smart card CD1 sends to an external terminal a message including the number N to be applied in S8, in order to allow the external terminal to invite the user UR to carry out the fingerprint acquisitions requested. This external terminal can be for example the external device (T1 or T2) with which the smart card CD1 is coupled or any other terminal.

The smart card CD1 performs in S10 an analysis of the N acquired fingerprints FG1. During this analysis, digital data DT1 representative of characteristic points MT of the N fingerprints FG1 are extracted by a reading of the image pixels PX at a predetermined resolution level RL. The analysis S10 can start after completion of the acquisition step S8 or, alternatively, the analysis S10 can be executed while the acquisition S8 is still in progress.

In a known manner, each fingerprint FG1 constitutes a representation of the dermo-epidermal ridges (or friction ridges) of a finger of a user UR. The geometry of these ridges forms a template specific to each person and allows them to be authenticated with great reliability. This template is characterized by characteristic points (also called singular points) denoted MT (FIG. 5).

During the analysis S10, the smart card CD1 thus reads all or part of the image pixels PX of the acquired fingerprints FG1 so as to extract therefrom the digital data DT1 mentioned above (FIG. 4). These digital data DT1 define characteristic points MT of each fingerprint FG1. In the example considered here, these characteristic points MT particularly comprise minutiae (local singular points), namely points of irregularity located on the papillary lines (terminations, bifurcations, islands, etc.). Other characteristic points MT can however be taken into account (global singular points).

According to one particular example, during the analysis S10, the smart card CD1 selects (S12) all or part of the image pixels PX of each fingerprint FG1. The pixels selected by the smart card CD1 in S12 are denoted PX1 (FIG. 5). The smart card CD1 then assesses (S14) the gray level (or the color) respectively characterizing each pixel PX1 selected in S12 so as to locate predetermined characteristic points MT in said concerned fingerprint FG1.

As described later, the smart card CD1 can act on various factors in S6 to adapt the resolution level RL (or resolution degree) applied during the reading S14 during the analysis S10.

During a generation step S16 (FIG. 4), the smart card CD1 generates a fingerprint template ML1 from at least the digital data DT1 obtained in S10. In the present case, the smart card CD1 generates (S16) the fingerprint template ML1 by aggregation of the digital data DT1 extracted in S10 from the N fingerprints FG1. As described later, other data can also be taken into account to generate the template ML1. The way in which the smart card CD1 processes the digital data DT1 to generate the fingerprint template ML1 is at the discretion of those skilled in the art, various implementations being possible.

It is assumed in the present case that there is no pre-existing fingerprint template ML stored in the memory MR2 of the smart card CD1 at the stage of the generation step S16. Also, the generation S16 amounts to creating a new fingerprint template ML1 from the digital data DT1 extracted in S10. In the case of generation of a new template, the digital data DT1 of the N fingerprints FG1 are aggregated together to form the new fingerprint template ML1.

According to one variant, during the generation step S16, the fingerprint template ML1 is generated from the digital data DT1 extracted in S10 and from a pre-existing fingerprint template ML, that to say a fingerprint template ML (for example ML2 described below) pre-recorded in the memory MR2. In this variant, the generation S16 therefore amounts to updating a pre-existing fingerprint template to generate the new fingerprint template ML1. In the case of a template update, the digital data DT1 of each fingerprint FG1 obtained in S8 are aggregated (S16), fingerprint-by-fingerprint, with (or in) the pre-recorded fingerprint template ML so as to obtain the updated fingerprint template ML1. The thus generated fingerprint template ML1 then replaces the pre-existing fingerprint template.

The fingerprint template ML1 generated in S16 (FIG. 4) serves as a reference fingerprint for later determining whether a fingerprint acquired during a subsequent authentication is valid or not. The template ML1 is created in such a way as to include information characterizing as faithfully as possible the anatomy of a finger of the concerned user UR. The template ML1 particularly comprises digital data DT1 representative of characteristic points MT, as already described.

During the generation step S16, the smart card CD1 records the fingerprint template ML1 in its memory MR2 to allow the subsequent authentication of fingerprints FG1 by comparison with the fingerprint template ML1 serving as a reference.

Thus, once the enrolment S3 is complete, the smart card CD1 can carry out an authentication step S18 based on the fingerprint template ML1 stored in memory. To do so, the smart card CD1 acquires one (or several) new fingerprint(s) FG1 by means of its fingerprint sensor 4 or an external device with which it cooperates. The smart card CD1 compares this new fingerprint FG1 with the fingerprint template ML. The smart card CD1 detects that the authentication S18 has passed successfully only if this fingerprint FG1 coincides with the template ML1. Otherwise, the authentication S18 fails or the authentication S18 continues based on another fingerprint acquisition FG1.

As indicated above, during the determination step S6 (FIG. 4), the smart card CD1 determines at least one parameter PT to be applied during the enrolment S3, namely at least one among the fingerprint acquisition number N applied in S8 and the resolution level RL characterizing the reading during the analysis S10 of the image pixels PX of the fingerprints FG1 to extract the digital data DT1 therefrom.

In accordance with the disclosure, at least one parameter PT among the number N and the resolution level RL is determined (or adapted) in S6 according to the applied mode (MD1 or MD2) during the enrolment (as detected in S6). Thus, said at least one parameter is set to be higher in the second mode MD2 than in the first mode MD1 so that the fingerprint template ML1 generated in S16 has a definition (or definition level, or quality) higher when the smart card CD1 operates in the second mode MD2 than when the smart card CD1 operates according to the first mode MD1 during the enrolment S3. The definition (or quality) of the fingerprint template ML1 is representative of the resolution and/or the amount of information stored in this template. The definition of the fingerprint template ML1 is for example characterized by the number of characteristic points MT (of minutiae for example) defined in the template ML, these points allowing a comparison with corresponding regions of a fingerprint to be verified. The definition of the fingerprint template ML1 can also be characterized by the amount or accuracy of the information characterizing each characteristic point MT, as described below.

According to a first particular example, the smart card CD1 adapts in S6 the number N according to the mode MD1/MD2 determined in S4. The resolution level RL can be kept constant regardless of the applied mode MD1/MD2. Particularly, the number N is adapted so that it is higher in the mode MD2 than in the mode MD1.

For example, the smart card CD1 is configured to require 8 fingerprint acquisitions FG1 in the second mode MD2 and only 5 fingerprint acquisitions FG1 in the first mode MD1, which allows speeding up the enrolment and limiting the resource and energy consumption when the smart card CD1 only has a limited power supply source (mode MD1). Conversely, the adaptation of the number N allows increasing the number of fingerprints FG1 used in the second mode MD2 to generate the fingerprint template ML, which leads to an increased quality of said template.

According to a second particular example, the smart card CD1 adapts in S6 the resolution level RL according to the mode MD1/MD2 determined in S4. The number N can be kept constant N regardless of the applied mode MD1/MD2. Particularly, the resolution level RL is adapted so that it is higher in the second mode MD2 than in the first mode MD1. The nature of this resolution level RL and the way in which it may be monitored are described below.

According to a third particular example, the smart card CD1 adapts in S6 the number N and the resolution level RL so that these are higher in the second mode MD2 than in the first mode MD1.

It is thus possible to act on various ways on the parameters N and/or RL, but insofar as the setting of the parameters PT leads to the generation in S16 of a fingerprint template ML1 having an increased definition or quality in the second mode MD2 compared to the first mode MD1.

Furthermore, it is possible to envisage various ways of monitoring the resolution level RL of the reading of the fingerprints FG1 carried out in S10 (FIG. 4). The resolution level RL of this reading is a function of (or comprises) various factors,—called resolution factors—on which the smart card CD1 can act alone or in combination to increase or lower the resolution level RL according to the applied mode MD1/MD2. Exemplary embodiments illustrating the monitoring of some of these resolution factors are described below.

As described previously, during the analysis S10 (FIG. 4), the smart card CD1 can select (S12) for each fingerprint FG1 pixels PX1 among all the pixels PX forming said fingerprint FG1. This selection can include all or part of the image pixels PX of each fingerprint FG1.

According to one particular embodiment, the smart card CD1 assesses in S14 a gray level (or a color) characterizing each pixel PX1 selected in S12. This assessment is carried out from a reading of each selected pixel PX1 and a reading of X neighboring pixels—denoted PX2—of said selected pixel PX1. In other words, to determine the gray level (or color) of a selected pixel PX1, the smart card CD1 reads (or analyzes) this pixel as well as X neighboring pixels PX2 (for example X predetermined neighboring pixels adjacent to said pixel PX1) and combines the gray levels (or color) obtained for all these pixels in order to deduce therefrom the gray level (or color) of the selected pixel PX1.

The number X is an integer greater than or equal to 0 (in one particular example, X≥1). In this particular embodiment, the smart card DV1 adapts in S6 (FIG. 4) this number X so as to be higher in the second mode MD2 than in the first mode MD1, which has the consequence of increasing the definition (or quality) of the fingerprint template ML1 obtained in the second mode MD2 with respect to the first mode MD1. This number X characterizes the resolution level RL of the reading of image pixels PX carried out in S10.

The smart card CD1 can for example apply a number X=20 in the first mode MD1 and X=200 in the second mode MD2.

Furthermore, during the assessment S14 (FIG. 4), the smart card CD1 can generate a gray level (or a color) representative of each pixel PX1 selected in S12. The smart card CD1 generates for example for each selected pixel PX1 a respective gray level (or color) encoded according to a predetermined encoding level denoted Y.

According to one particular embodiment, this encoding level Y is adapted by the smart card CD1 in S6 (FIG. 4) so as to be higher in the second mode MD2 than in the first mode MD1, which has the consequence of increasing the definition (or quality) of the fingerprint template ML1 obtained in the second mode MD2 with respect to the first mode MD1. This factor Y characterizes the resolution level RL of the reading of image pixels PX carried out in S10.

By way of example, the smart card CD1 can encode the gray level (or color) of each pixel PX1 selected on Y=8 bits in the first mode MD1 and on Y=16 bits in the second mode MD2. The higher the number of encoding bits, the higher the resolution level RL of the reading S14 (and therefore of the digital data DT1 thus extracted). The algorithm implemented by the smart card CD1 to read the color of the image pixels PX can thus be parameterized appropriately by adapting the resolution of the color coding according to the mode MD1/MD2 applied during the enrolment S3.

According to one particular embodiment, the smart card CD1 defines (or adapts) in S6 the number (or the proportion) of pixels PX1 selected in S12 to carry out the reading of the gray levels. The smart card CD1 can adapt the number of selected pixels PX1 so that it is higher in the second mode MD2 than in the first mode MD1. The higher the number of pixels PX1 selected in S12, the higher the resolution level RL of the reading S14 (and therefore of the digital data DT1 thus extracted). In this case, this number of pixels PX1 per fingerprint FG1 characterizes the resolution level RL of the reading of image pixels PX carried out in S10.

According to one particular embodiment, the smart card CD1 carries out the acquisition S8 and the analysis S10 of the N fingerprints FG1 in a predetermined time range, this time range being adapted by the smart card CD1 during the enrolment S3 so as to be longer in the second mode MD2 than in the first mode MD1. By thus parameterizing the temporal aspect of the processing of the fingerprints FG1, the smart card CD1 advantageously has the allotted/allocated time to carry out the enrolment S3 according to the chosen resolution level RL.

The present disclosure advantageously allows the smart card CD1 to reliably and efficiently authenticate a user by means of fingerprints. Thanks to aspects of the disclosure, the smart card CD1 can carry out authentications by fingerprint in an optimal manner despite the variable contexts in which a user and the smart card may be.

It is common for a user not to correctly enroll his fingerprint with a smart card. Even if the enrolment procedure is followed, the quality of the fingerprint template thus generated is not always sufficient. Thus, many situations may require an increased fingerprint template quality to compensate for various disturbances affecting the performances of the authentication. For example, changing climatic conditions (temperature, humidity, etc.) or a variation over time of the performances of the fingerprint sensor may result in a fingerprint template not being sufficiently accurate to allow for a reliable authentication in all circumstances.

However, the generation of a high-definition fingerprint template requires time and processing resources that are not always available for a smart card. The resources available are intrinsically related to the electrical power supply available to the smart card to carry out the enrolment. Due to the various internal and external power supply sources that a smart card can use depending on the case, it is necessary to adapt the way in which a fingerprint enrolment is carried out according to the context in which the smart card may be.

Thus, the disclosure allows generating a fingerprint template as rich and as complete as possible, within the limits imposed by the electrical power supply (and therefore processing) resources available to the smart card to execute the enrolment.

A user can for example carry out a more faithful enrolment when his smart card is coupled by contact with a case (having a large battery) than when his smart card is contactlessly coupled with a Smartphone (configured to provide a limited electrical power supply).

The smart card of the disclosure is thus capable of generating faithful fingerprint templates vis-à-vis the users, while optimizing the use of the resources of the smart card. To do so, the smart card adapts the enrolment parameterization according to the level of the available power supply source. As described above, the number N of fingerprints used and/or the resolution level RL for the reading of these fingerprints can be adapted to guarantee a higher definition of the fingerprint image template in the second mode MD2 than in the first mode MD1. To increase or decrease the resolution level RL, various resolution factors described above can be adapted (either one or a plurality at the same time).

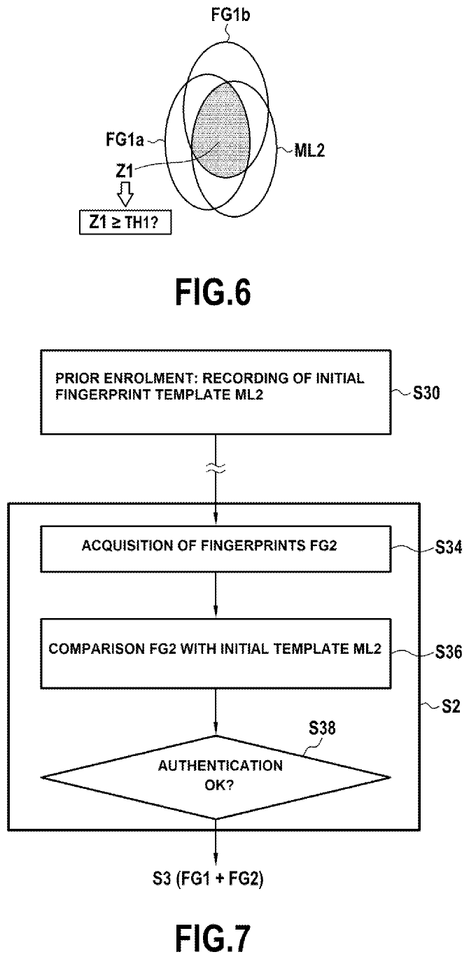

According to one particular embodiment represented in FIG. 6, during the enrolment S3 (FIG. 4), the smart card CD1 determines a level of overlap of each first fingerprint FG1 obtained in S8 vis-à-vis another first fingerprint FG1 obtained in S8 or vis-à-vis a pre-existing fingerprint template from which the fingerprint template ML1 is generated during the generation S16. More particularly, in the particular case where the enrolment S3 does not aim an update of a pre-existing fingerprint template (i.e. when it is a question of generating a new template), then the smart card CD1 determines a level of overlap of each first fingerprint FG1 obtained in S8 vis-à-vis another first fingerprint FG1 obtained in S8 (for example vis-à-vis the fingerprint FG1 acquired first during the acquisition S8). On the other hand, in the particular case where the enrolment S3 aims an update of a pre-existing fingerprint template (for example the predefined template ML2 described below), the smart card CD1 determines a level of overlap of each first fingerprint FG1 obtained in S8 vis-à-vis the pre-existing fingerprint template.

FIG. 6 illustrates for example an area of overlap Z1 between 2 fingerprints FG1a and FG1b and a predefined fingerprint template ML2 corresponding to the same finger. An level of overlap characterizes the degree of similarity of the fingerprints together or vis-à-vis a fingerprint template ML, this degree being a function of the extent of the considered overlap area Z1.

The smart card CD1 then verifies, for each first fingerprint FG1 obtained during the enrolment S3, whether the determined level of overlap reaches a predetermined minimum level of overlap TH1. During the generation step S16 (FIG. 4), the fingerprint template ML1 is then generated from the digital data DT1 extracted from each first fingerprint FG1 for which the associated level of overlap reaches the predetermined minimum level of overlap TH1. Thus, the template ML1 generated in S16 does not take into account each fingerprint FG1 that does not reach the required minimum level of overlap TH1. According to one particular example, the minimum level of overlap TH1 is such that TH1=400 pixels (corresponding to a square of 20 pixels×20 pixels).

The verification of the level of overlap allows the smart card CD1 to verify whether it is capable of aggregating together the different fingerprints to form a fingerprint template ML1. The fingerprint common part is used during the generation of the fingerprint template ML to verify that each acquired fingerprint is a fingerprint of the same finger (possibly of the same finger as that of the pre-existing fingerprint template) and to accurately aggregate the digital data extracted from each fingerprint FG1 together and/or with a pre-existing fingerprint template (FIG. 4).

According to this embodiment, the smart card CD1 adapts the minimum level of overlap TH1 during the first enrolment S3, so as to be higher if no initial enrolment (other than the enrolment S3) has been carried out prior to the enrolment S3 (FIG. 4). Thus, the enrolment S3 can, depending on the case, be the very first enrolment (initial enrolment) carried out during the initial configuration of the smart card CD1 or, alternatively, be a subsequent enrolment (for example an update after a given use time). To determine whether the enrolment S3 considered is the initial enrolment or not, the smart card CD1 can consult its memory to determine whether it already contains a fingerprint template. If not, this means that no prior enrolment has been carried out from the point of view of the smart card CD1.

The smart card CD1 can thus act on the level of overlap TH1 required between the fingerprints FG1 acquired during the enrolment S3 to authorize the aggregation of the fingerprints, depending on the type of enrolment considered. The higher the minimum level of overlap TH1, the less the smart card CD1 tolerates significant movements of the finger of a user between each fingerprint acquisition, and possibly the pre-recorded fingerprint template ML2, during the enrolment S3.

During an initial enrolment, it can be assumed that the biometric fingerprint sensor has optimal performances. However, changes can degrade the performances of the sensor over time. The smart card CD1 can therefore advantageously adapt the minimum level of overlap TH1 during the first enrolment S3, so as to be higher if the enrolment S3 considered is an initial enrolment (no other enrolment has been carried out beforehand) than if the enrolment S3 considered is a subsequent enrolment (updated subsequently to the initial enrolment).

Thus, for the initial enrolment, a higher minimum level of overlap TH1 can be required in order to obtain a good quality initial fingerprint template. For the subsequent enrolments, the level of overlap required can be lower because anatomical changes may have affected the user's fingers and/or sensor changes may also have occurred.

One particular embodiment is now described with reference to FIG. 7. It is assumed in this example that a preliminary enrolment (or initial enrolment) S30 is executed by the smart card CD1 before the enrolment S3 described above (FIG. 4). During this initial enrolment, an initial fingerprint template ML2 is generated and recorded in the memory MR2. This template ML2 can be generated in any way from one or a plurality of fingerprints acquired by the smart card CD1. According to one particular example, the preliminary enrolment S30 is executed similarly to the enrolment S3.

Following the preliminary enrolment S30, the smart card CD1 carries out the authentication S2 (FIG. 4) to authenticate a user UR prior to the enrolment S3. In this particular example, the enrolment S3 is therefore not a preliminary enrolment but a new enrolment, which aims for example to update the initial fingerprint template ML2.

During the authentication S2, the smart card CD1 acquires (S34, FIG. 7) at least one fingerprint denoted FG2, by means of the fingerprint sensor 4 or by using any external device embedding such a sensor. These fingerprints FG2 acquired in S34 constitute “second” fingerprints within the meaning of the disclosure. The smart card CD1 compares in S36 said at least one second fingerprint FG2, or data obtained from said at least one second fingerprint FG2, with the initial fingerprint template ML2 pre-recorded in the memory MR2 of the smart card CD1 during the preliminary enrolment S30. The smart card CD1 determines in S38 that the authentication S2 has passed successfully from the result of the comparison S36. More specifically, if said at least one second fingerprint FG2 (or the data obtained therefrom) coincides with the initial template ML2, the authentication S2 has passed successfully. Otherwise, the authentication fails or may possibly continue from at least one new fingerprint acquisition FG2.

The enrolment S3 described above is then executed by the smart card CD1 upon detection that the authentication S2 has passed successfully.

As already described, during the enrolment S3, the fingerprint template ML1 is generated in S16 (FIG. 4) from the fingerprints FG1 obtained in S8. In this particular example, the first fingerprints FG1 obtained in S8 comprise at least one fingerprint selected among the second fingerprint(s) FG2 acquired during the authentication S2 preceding the enrolment S3. In other words, the obtaining step S8 (FIG. 4) comprises the selection, as a first fingerprint FG1, of at least a second fingerprint FG2 acquired during the prior authentication S2. This selection is for example made so as to select only the second fingerprint(s) FG2 which have a predetermined minimum level of overlap (or a level of coincidence) with the predefined fingerprint template ML2. During this obtaining step S8, the smart card CD1 can, in addition to the selection of at least a second fingerprint FG2 as first fingerprints FG1, acquire one or several other new fingerprint(s) as first fingerprints FG1, in order to reach the number N of first fingerprints FG1 that it is necessary to obtain to carry out the analysis step S10 (FIG. 4).

Thus, the smart card CD1 can obtain in S8 the N first fingerprints FG1 by selection of at least one fingerprint FG2 already acquired during the authentication S2 preceding the enrolment S3 and/or by acquisition of at least one new fingerprint FG1 during the enrolment S3. The use of all or part of the fingerprints FG2 acquired during the authentication S2 to generate in S16 (FIG. 4) the fingerprint template ML1 allows significantly speeding up the enrolment S3 and enriching the fingerprint template ML1 while limiting the necessary processing and time resources. The use of the fingerprints FG2 acquired during the authentication S2 to generate the template ML1 can be done transparently for the user. Thus, if the smart card CD1 acquires 5 fingerprints FG2 during the authentication S2 and if the latter has passed successfully, the smart card selects these 5 fingerprints as first fingerprints FG1 and in addition acquires only 3 new fingerprints FG1 during the enrolment S3 to obtain the amount of digital data DT1 necessary for the generation of a good quality fingerprint template ML1 (N=8). According to another example, if 8 fingerprints FG2 are acquired during the authentication S2 which passed successfully, the smart card CD1 selects these 8 fingerprints as first fingerprints FG1 and therefore does not need to acquire new fingerprints FG1 during the enrolment S3 to obtain the amount of digital data DT1 necessary for the generation of a good quality fingerprint template ML1 (N=8). According to one particular example, out of 8 fingerprints FG2 acquired (S34) during the authentication S2, the smart card CD1 selects only 6 fingerprints among the 8, upon detection that only these 6 fingerprints reach a predetermined minimum level of overlap with the pre-existing fingerprint template ML2.

In the example represented in FIG. 7, it is thus assumed that the fingerprint template ML1 is generated in S16 (FIG. 4) from the digital data DT1 extracted in S10 and from the fingerprint template ML2 pre-recorded in the memory MR2. The generation S16 therefore amounts to updating a pre-existing fingerprint template to generate the new fingerprint template ML1. In this case, the digital data DT1 of each first fingerprint FG1 obtained in S8 (by acquisition and/or selection) are aggregated (S16), fingerprint-by-fingerprint, with (or in) the pre-recorded fingerprint template ML2 so as to obtain the updated fingerprint template ML1. The fingerprint template ML1 thus generated then replaces the pre-existing fingerprint template ML2.

It should be noted that the order in which the steps of the enrolment method are linked to each other as described previously in particular with reference to FIGS. 4 and 7 only constitutes one exemplary embodiment, variants being possible.

Those skilled in the art will understand that the embodiments and variants described above only constitute non-limiting exemplary implementations of the disclosure. Particularly, those skilled in the art may envisage any adaptation or combination of the embodiments and variants described above in order to meet a very specific need.

1. A fingerprint enrolment method implemented by a smart card comprising a memory, the method comprising the execution of a first enrolment by using an electrical power supply provided by a power supply source internal or external to said smart card, said first enrolment comprising:
obtaining of N first fingerprints in the form of image pixels representative of said fingerprints, N being an integer greater than or equal to 2;
analyzing of the N obtained first fingerprints, in which digital data representative of characteristic points of said fingerprints are extracted by a reading of the image pixels at a predetermined resolution level;
generating a fingerprint template by aggregation of at least said digital data extracted from the N first fingerprints;
determining a mode, called applied mode, in which the first enrolment is carried out, the applied mode being a first mode if the electrical power supply is below a predefined threshold and being a second mode if the electrical power supply is above or equal to the predefined threshold; and
adapting at least one parameter among said number N and said resolution level according to the mode applied during the first enrolment, said at least one parameter being set to be higher in the second mode than in the first mode so that the fingerprint template has a higher definition level in the second mode than in the first mode.

2. The method according to claim 1, further comprising:
recording of the fingerprint template in the memory to allow subsequent authentication of fingerprints by comparison with the fingerprint template.

3. The method according to claim 1, wherein the electronic device acquires the fingerprints by means of a fingerprint sensor embedded in said electronic device or by cooperating with an external device comprising a fingerprint sensor.

4. The method according to claim 1, further comprising:
acquiring a signal from an external device with which the smart card cooperates during the first enrolment; and
determining, from the signal, the mode applied during said first enrolment by applying a predefined rule.

5. The method according to claim 1, wherein the smart card comprising at least one communication interface for cooperating with at least one external device, the smart card being able to receive, via said at least one communication interface, an electrical power supply from said at least one external device serving as a power supply source;
wherein the smart card determines the mode applied during said first enrolment according to the use of said at least one communication interface.

6. The method according to claim 1, wherein the characteristic points comprise fingerprint minutiae.

7. The method according to claim 1, wherein the number N of first fingerprints obtained to carry out the first enrolment is adapted so as to be higher in the second mode than in the first mode, the amount of aggregated digital data to generate the fingerprint template being a function of the number N.

8. The method according to claim 1, wherein the predetermined resolution level applied during the analysis is adapted so as to be higher in the second mode than in the first mode, the amount of aggregated digital data to generate the fingerprint template being a function of said predetermined resolution level.

9. The method according to claim 1, wherein said analysis comprises:
the selection of all or part of the image pixels of each first fingerprint; and
the assessment of a color characterizing respectively each selected pixel so as to locate predetermined characteristic points in said first fingerprint.

10. The method according to claim 9, wherein said assessment of a color of each selected pixel is carried out from a reading of said selected pixel and a reading of X pixels neighboring said selected pixel, X being an integer greater than or equal to 0 which is adapted to be greater in the second mode than in the first mode.

11. The method according to claim 9, wherein said assessment comprises the generation, for each selected pixel, of a respective color encoded according to a predetermined encoding level, the predetermined encoding level being adapted so as to be of better quality in the second mode than in the first mode,
the digital data being extracted from the encoded colors for each selected pixel.

12. The method according to claim 1, wherein the first enrolment further comprises:
determining, for each first fingerprint obtained during said first enrolment, a level of overlap of said first fingerprint vis-à-vis another first fingerprint or vis-à-vis a pre-existing fingerprint template from which said fingerprint template is generated during said generation; and
verifying, for each first fingerprint, that the determined level of overlap reaches a predetermined minimum level of overlap, the predetermined minimum level of overlap being adapted so as to be higher if no initial enrolment, other than the first enrolment, was carried out prior to the first enrolment than in the opposite case;
wherein the fingerprint template is generated from the digital data extracted from each first fingerprint for which the level of overlap reaches the predetermined minimum level of overlap.

13. The method according to claim 1, wherein the first enrolment is executed upon detection that an authentication has previously passed successfully, the authentication comprising:
acquiring second fingerprints;
determining that the authentication has passed successfully from a comparison of the second fingerprints, or data obtained from the second fingerprints, with an initial fingerprint template pre-recorded in the memory of the smart card during an initial enrolment before the execution of the first enrolment;
wherein, during the first enrolment, the first fingerprints obtained comprise at least one fingerprint selected among the second fingerprints acquired during said authentication.

14. A computer program including instructions for the execution of the steps of an enrolment method according to claim 1 when said program is executed by a smart card.

15. A smart card configured to carry out a fingerprint enrolment by using an electrical power supply provided by a power supply source internal or external to said smart card, comprising:
a memory;
a determination module configured to determine a mode, called applied mode, in which the first enrolment is carried out, the applied mode being a first mode if the electrical power supply is below a predefined threshold and being a second mode if the electrical power supply is above or equal to the predefined threshold (ALm);
an obtaining module configured to obtain N first fingerprints in the form of image pixels representative of said fingerprints, N being an integer greater than or equal to 2;
an analysis module configured to carry out an analysis of said N first fingerprints, in which digital data representative of characteristic points of said fingerprints are extracted by a reading of the image pixels at a predetermined resolution level; and
a generation module configured to generate a fingerprint template by aggregation of at least said digital data extracted from the N first fingerprints,
wherein the determination module is further configured to adapt, according to the applied mode, at least one parameter among said number N and said resolution level, said at least one parameter being set to be higher in the second mode than in the first mode such that the fingerprint template has a higher definition level in the second mode than in the first mode.
